(19) United States
(12) Patent Application Publication
(10) Pub. No.: US 2012/0271692 A1
(43) Pub. Date: Oct. 25, 2012

(54) Method and System for Smart Phone Based Virtual Card

(76) Inventors: Xingang Huang, San Jose, CA (US); Xiongwei He, San Jose, CA (US); Tong Jiang, Fremont, CA (US); Zhi Ning Wang, San Jose, CA (US)

(21) Appl. No.: 13/092,929

(22) Filed: Apr. 23, 2011

(51) Int. Cl. G06Q 30/00

(52) U.S. Cl. 705/14.23; 705/26.1; 705/16

(57) ABSTRACT

The present invention discloses Virtual Card Mobile App (VCMA) as a medium for replacing real world commercial wallet cards. VCMA furnishes a consumer with a UVC service, which enables a consumer to easily obtain, manage and use Vendor Virtual Cards (VVC) that are offered by vendors. VCMA allows users to carry unlimited number of virtual cards from unlimited number of vendors. VCMA makes it much easier and more secure for a user to sign up, carry, manage and use a card. It also enables user to perform many functions, such as checking balances, checking rewards, searching specials, checking product info, ordering products, and making payments. User can not perform these functions using traditional physical cards. In the present invention, VCMA and virtual card services are managed by a central card management system (CCMS). CCMS also provides virtual card operation services to vendors, so that vendors can issue virtual cards, provide card services, and administer card services. Moreover, CCMS serves as a broker between a user and a vendor. Credential and private information, such as address, phone, age, password, pin and payment account number, are stored in CCMS, not with the vendor. When a transaction is performed, the credential information never goes through a vendor's equipment. Therefore, the system provides better security and privacy.

### TECHNICAL FIELD

The disclosed embodiments relate generally to smart phone and Internet-based e-commerce, and more particularly, virtualizing traditional wallet cards by using smart phone and connected computer servers.

### BACKGROUND

Today's business world is experiencing unprecedented growth in the number and variety of offerings of wallet cards. These cards can be classified into several major categories including reward card, prepaid card, and membership card, or their combinations.

Examples of reward cards include airline mileage cards with products that can be redeemed from mileage traveled, and specialty drink shop stamp cards with the Nth drink for free. Reward cards are offered by vendors to encourage repeat business, gain customer loyalty, and track usage. Consumers use reward cards to save money.

Examples of prepaid cards include gift cards, preloaded stamp cards, and phone cards. Vendors offer prepaid cards to customers to receive early payment and a commitment to buy, to promote business brands, and to increase customer loyalty. Prepaid cards often carry bulk rate discount to give consumers monetary benefits. Prepaid cards also provide a mechanism for building relationships and bonds. A gift card purchaser can give it to family and friends on special occasions. Employers can reward employees with a gift card for excellent performance. Comparing to cash, gift cards are often more memorable and more effective for relationship building.

Membership cards give consumer privileges to use vendor's services. They generally require a sign-up process. They often require identity verification before use. Many membership cards have membership fees, including initiation fee, annual fee or monthly fee. Vendors can use membership cards to offer differentiated services to different consumer groups, to obtain a steady stream of revenue, and to build a stable user group base. Benefits to consumers include discount, convenience, differentiated service, and perceived social status for exclusivity.

As consumers acquire more cards from vendors, managing these cards becomes a burden. Physical cards take space. Consumers can carry only a small number of cards in their wallet, usually less than 20. Other cards, usually the less frequently used ones, have to be stored somewhere and be tracked of. It's a challenge to have the right card for the right occasion. Some consumers try to squeeze too many cards (near or more than 20) in their wallets. It is often frustrating for them to find and extract a card to use and squeeze it back into the crowded wallet after use.

There are other inconveniences in using cards. Losing a prepaid card is same as losing cash. Applying for membership card is often a tedious manual process involving filling out long forms. Consumers generally have privacy concerns about providing personal information to vendors. It is difficult for consumers to track balance on reward and prepaid cards. In order to get the card balance, the consumer has to call customer service, visit the vendor's website, or visit the store.

The inconveniences of cards result in a love/hate relationship between consumers and cards. Particularly, consumers are often reluctant to accept a new card. Accepting a new card usually means the sacrifice of an existing card: an existing card may be trumped and have to leave the wallet. The new card better offers more benefits than one of the existing cards to have a chance.

On the other hand, card issuing vendors want more consumers to carry their cards. They have to compete for a precious resource: the limited space in consumers' wallet. Issuing a card has cost in design, manufacturing, distribution and operation. To increase the competitiveness of one's card, a vendor may need to increase discounts and benefits of its card, which may further cut the profit margin of the vendor's business. Due to limited cost-effectiveness, majority of vendors choose not to issue cards.

In summary, issuing cards is a proven and effective marketing tool to create a win-win situation between consumers and vendors. However, the number of physical cards consumers can carry is limited by their wallet space. This physical limitation, together with other inconveniences and cost of physical cards, have greatly affected the effectiveness and the usage of physical cards. There exists a need for cards to be more easily issued, carried, used, and managed.

There are several ongoing efforts to solve these issues. One well-known method is to combine multiple types of card functionality into one physical card. However, all solutions are still using physical media. Prior multi-purpose card solutions are disclosed in U.S. Pat. Nos. 6,715,679, 6,631,849 and Patent application US 2006/0131393, each of which is expressly incorporated herein by reference in its entirety.

### SUMMARY

In the present application, term “vendor” not only covers a party that sells merchandises and services for profit, it also can be a non-profit organization, such as a community library. Sometimes, the terms vendor and service provider are used interchangeably. Similarly, the term “business” is used not only in the context of profit-driven activities, but also various non-profit operations. Term “user” in the present application is used for an individual who is a card holder and is a consumer of the products and services provided by vendors. Therefore, terms consumer and user are used interchangeably. Term device means a general purpose computing device in present application.

In the near future, most consumers will have a smart phone with them all the time. Smart phone based Universal Virtual Card (UVC) described in the present invention effectively addresses the card inconvenience issues for consumers and operational cost issues for vendors. The present invention virtualizes real world physical cards with a smart phone app. The Virtual Card Mobile App (VCMA) furnishes a user with a UVC service, which enables a user to easily obtain, manage and use unlimited Vendor Virtual Cards (VVC) that are offered by vendors.

It is an objective of the present invention to remove the physical space limitation for carrying cards by introducing smart phone based VCMA. VCMA gives a consumer the ability to carry unlimited number of cards from unlimited number of vendors. A consumer will always have all the Vendor Virtual Cards he wants with him. There will be no Vendor Virtual Cards left behind.

It is also an objective of the present invention to make it easier for consumers to find the right vendor card to use even if they have a large number of virtual cards in possession. VCMA can automatically present relevant vendor virtual cards to the user based on context information such as smart phone location, time, or consumer profile. Context information can be used to further assist manual search by the consumer. Hundreds or even thousands of cards can be quickly narrowed down to a few.

It is another objective of the present invention to enable consumer to access vendor services anywhere and anytime when the services are available through the use of virtual cards. VCMA and VVC can serve as a portal or user interface for user to easily access any services a vendor may provide. These services may include checking balances, checking rewards, searching specials, checking product info, ordering products, and making payments. It is often impossible for traditional wallet cards to provide similar functionalities.

It is a further objective of the present invention to protect the privacy information of consumers from vendors. Examples of consumers' privacy information include date of birth, email addresses, telephone numbers, and physical address. This type of information is stored in a central card management system (CCMS) when a consumer registers for UVC service. Vendors need explicit authorization from consumers to access the information. Otherwise, vendors can only access the statistic information of their card users.

It is a further objective of the present invention to protect consumers' credential information from vendors. CCMS serves as a broker between a consumer and a vendor. Credential information, such as personal pin number, passwords and payment account numbers, only needs to be sent to CCMS and stored in CCMS. It does not need to go through vendor's point of sale equipments, or any vendor's equipments.

It is yet an additional objective of the present invention to improve the user experience for signing up vendor cards. Since user profile data are stored in central card management system (CCMS), user does not need to provide the same information twice any time.

It is yet an additional objective of the present invention to reduce vendor's marketing and operational cost through the use of virtual cards. CCMS can provide vendors with software and services such as issuing and administrating virtual cards, distributing coupons, publishing specials and product information, and taking orders and reservations. Vendors can use these services either free, or at a fractional cost compared with traditional approaches.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 shows the overview of the virtual card system including VCMA, CCMS and vendor's POS computing device.

FIG. 2 illustrates CCMS functionalities include consumer and vendor account management and virtual card service management.

FIG. 3 illustrates VCMA and vendor POS device functionalities and interaction with the CCMS.

FIG. 4 illustrates the flow of one sample design of VCMA for a user to register with CCMS and sign up for the UVC.

FIG. 5 shows the flow chart of one sample design of CCMS online vendor registration service.

FIG. 6 shows the flow chart of a 1-800 call service that CCMS can provide for a vendor to verify his registered business in CCMS.

FIG. 7A shows the flow chart of CCMS self-service for vendor to issue a virtual stamp reward card.

FIG. 7B illustrates a UI design of virtual stamp reward card customized with specific vendor information.

FIG. 8 illustrates the message sequence diagram when a virtual card user is requesting reward in a store.

FIG. 9 illustrates the message sequence diagram of a user making payment using his virtual card at a store.

### DETAILED DESCRIPTION

Reference will now be made in detail to some embodiments of the invention, examples of which are illustrated in the accompanying drawings. Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims. While the claimed subject matter will be described in conjunction with these embodiments for illustration purposes, it will be understood that they are not intended to limit the claimed subject matter to these embodiments. On the contrary, the claimed subject matter is intended to cover alternatives, modifications and equivalents, which can be included within the spirit and scope of the claimed subject matter as defined by the appended claims. Furthermore, in the following detailed description of the present claimed subject matter, numerous specific details are set forth in order to provide a thorough understanding of the present claimed subject matter. However, it will be evident to one of ordinary skill in the art that the present claimed subject matter could be practiced without these specific details.

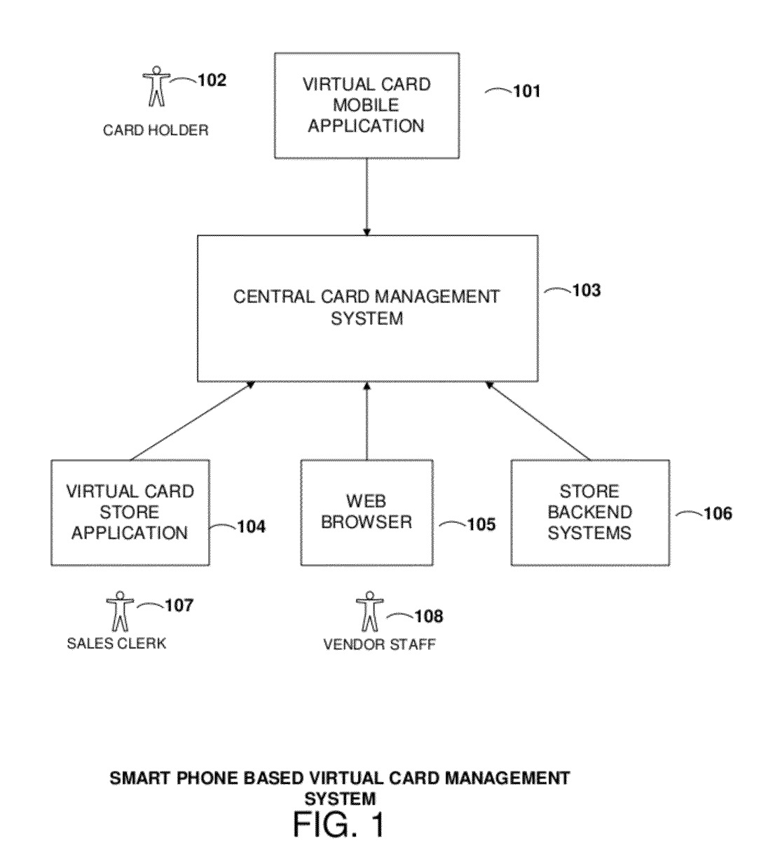

FIG. 1 shows overall architecture of a smart phone based UVC system. VCMA 101 is a software application running on smart phone such as iPhone or Google Android phone. When user 102 starts VCMA 101 the first time, VCMA 101 connects to CCMS 103 to allow user 101 to register with CCMS 103 by providing user profile data. As a result, a user id is assigned to the VCMA 101 by CCMS 103. Similarly, a vendor staff 108 working at a merchant vendor or service provider business can register with CCMS 103 as a vendor by providing business profile. Vendor registration can be performed over Internet using a web browser 105. Using web browser 105, vendor staff 108 can offer a virtual card service by logging into CCMS 103 and inputting card service related information such as card service name, reward/discount policy and membership qualification etc. VCMA 101 allows user 102 to sign up a virtual card service offered by a registered vendor. For performing commercial transactions at a vendor point of sale (POS), virtual card store application (VCSA) 104 receives identification of VCMA 101 either by communicating with VCMA 101 or accepting input by sales clerk 107. Then, various activities, such as purchase, make a payment, redeem a coupon and reward can be conducted under coordination of CCMS 103. Web browser 105 also allows vendor staff 108 updating information related to the card services. When store backend system 106, such as an inventory system, is connected to the CCMS 103, card service related information, such as product catalogue, price and availability, as well as coupons and specials, can be updated into CCMS 103. Therefore, users who have signed up the card service can see the information in real time.

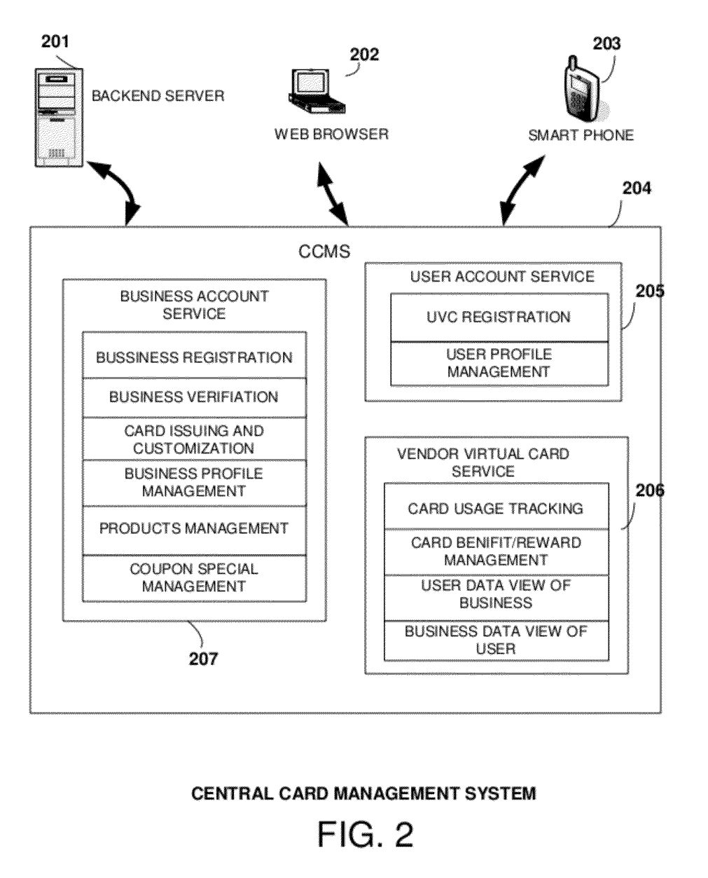

FIG. 2 illustrates the main functionalities provided by CCMS in details. In FIG. 2, CCMS 204 consists of three groups of functionality. Business account service block 207 processes information submitted by vendors via web browser 202. When block 207 receives a request from vendor to register for universal virtual card service, a business account is created based on the business profile provided. The account will be activated after verification process is completed. For vendor with an active business account, it can send request to CCMS 204 to issue a virtual card service, such as membership card, prepaid card or reward card. Business profile management keeps information about the business, including the type of business products or services, locations, operation schedule and contact information. By communicating to the vendor's backend server with inventory data, block 207 keeps track of product/merchandise catalogue, availability and price etc. The vendor can also submit coupon or special deal offering to CCMS 204 via web browser 202. Block 207 will publish these specials to universal virtual card subscribers. User account service block 205 is responsible for processing universal virtual card consumer registration from VCMA running on smart phone 203, creating consumer user account, and storing all user profile data. Vendor virtual card service block 206 keeps track of consumer subscribers for each card service and how many times a user has used a particular card service. For example, when a user signs up a card service, his account is added into the list of all subscribers of the card service. When a card service is used by a user, transaction history is saved by block 206 as well. It also manages what benefit/reward is eligible for each user. Access control is also imposed so only public portion of user data is visible to a vendor. At the same time, user can only see a vendor's published information.

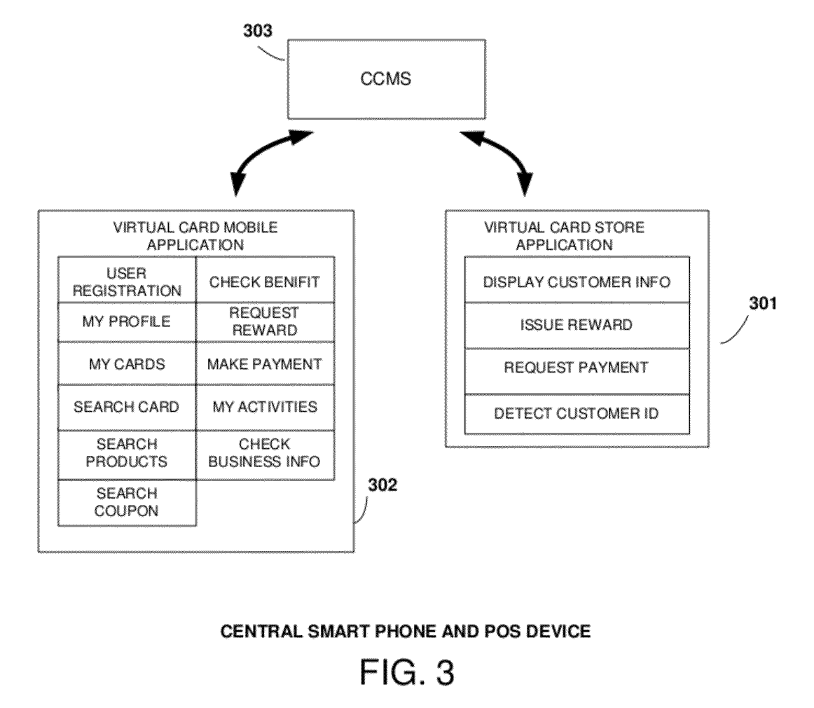

Referring now to FIG. 3, which illustrates the functionalities of Virtual Card Mobile Application (VCMA) 302 running on a user's smart phone and virtual card store application (VCSA) 301 running on a vendor's point of sale (POS) computer. VCMA 302 provides graphic user interface (GUI) for the user to register with CCMS 303 by sending user profile information such as name, address, phone numbers as well as user login credential, i.e., user name and password. In one specific embodiment, user profile and credential can be obtained from the user's another online account, instead from manual input. User can also search virtual cards offered by vendors. Through a vendor virtual card, user can access vendor's information, including business category, schedule, business description, telephone numbers and addresses. User can also access the information about currently available products and services provided by the vendor, including price, availability, specifications and descriptions. If user finds a vendor virtual card interesting, he can add the card into “MY CARDS”. “MY CARDS” is a shortlist of VVCs for user to keep track of his interested cards. VVCs that user has conducted business transactions with are automatically added into “MY CARDS” too. VCMA 302 also lets user to search various discount and coupons offered by vendor, check current benefits and what rewards are redeemable. It is also possible for user to make a payment using VCMA 302. In one embodiment, VCSA 301 is a software application running on a general-purpose computing device at vendors' POS location. By communicating with VCMA 302, VCSA 301 can detect customer's identification and display customer's information. VCSA 301 helps vendor's sales staff perform business transactions, such as issuing reward, redeeming a coupon, or requesting a payment in an accurate and efficient way.

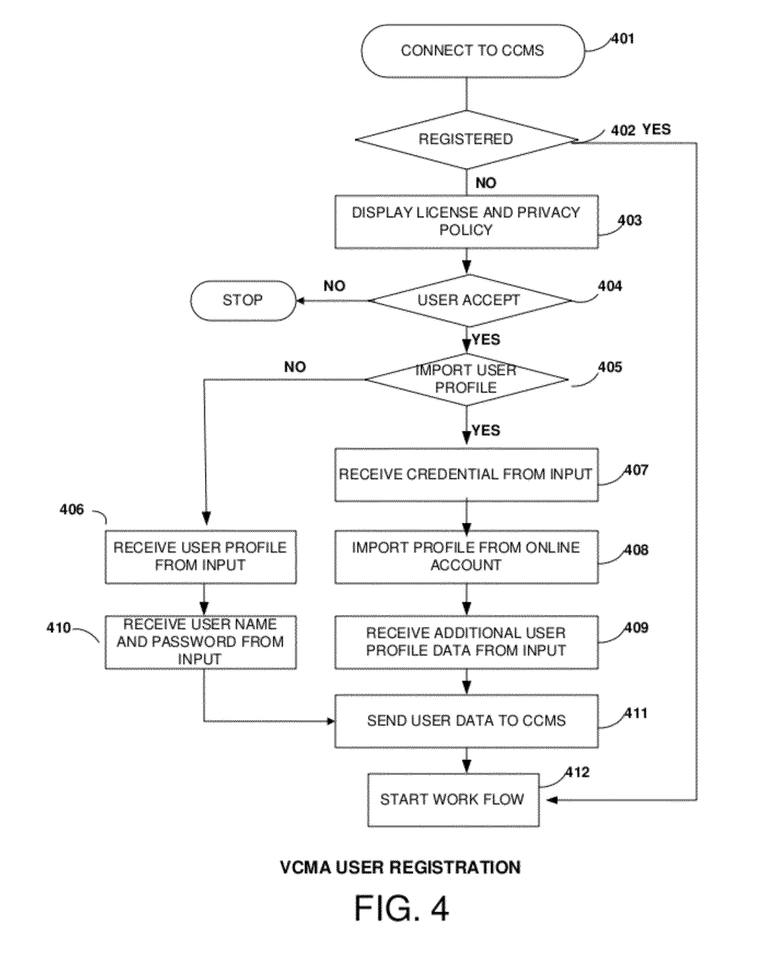

FIG. 4 illustrates the control flow for VCMA registering universal virtual card (UVC) service with CCMS. At block 401, when VCMA starts, it connects to CCMS automatically with user ID associated with the smart phone. If CCMS cannot recognize the user ID, it sends UVC license and privacy policy which is displayed on the smart phone screen at block 403 for user review. Otherwise, CCMS informs VCMA that the user is registered, then VCMA moves on to the regular work flow at block 412. After the user accepts the policy at 404, at block 405, VCMA allows user to choose whether to input user information manually or import from an existing online account. In manual input mode, VCMA receives user profile from user input at block 406 and user credential (user name and password) for UVC at block 410. In automatic import mode, user need to enter the credential of an existing online account at block 407, such as Facebook. VCMA then imports user profile from the online account at block 408. At block 409, user needs to input additional data required by UVC. After collecting the information required for UVC registration, VCMA sends user data to CCMS at block 411. After receiving confirmation of successful registration, user can use VCMA for other workflows at block 412.

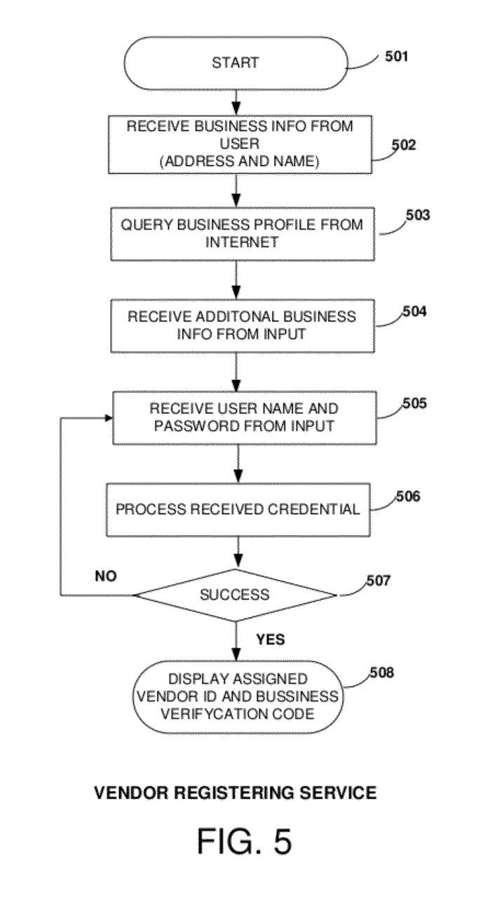

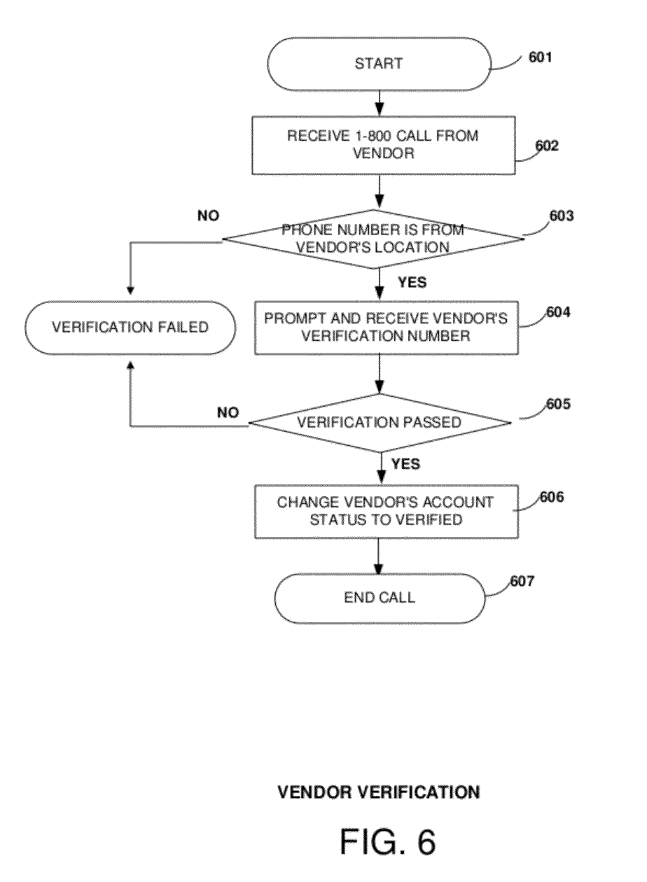

Flow chart in FIG. 5 shows the process for CCMS allowing a vendor to register with UVC via a web interface. After a vendor staff starts the registration process at block 501, CCMS first acquires business information such as business name and address at block 502. To reduce manual input for vendor staff, CCMS then query profile about this business over the Internet at block 503. At block 504, CCMS requests additional information that is needed for registration but not available on the Internet. These information need to be input by vendor staff manually. The vendor staff then input the user name and password for the UVC business account at block 505. At block 506 the credential is validated for meeting minimum security requirement and without duplicating with existing accounts. If the validation failed, CCMS will prompt the vendor staff to reenter the credential at block 505. Otherwise, CCMS displays the assigned vendor ID and business verification code that will be used during the verification process illustrated in FIG. 6.

After the registration of a business UVC account, a vendor often needs to verify that he is the real owner of the business. Before verification, CCMS still allows the vendor to publish business information and issue virtual cards. But the information and the cards will be labeled as “Unverified” to alert users about the situation. CCMS will also disable the vendor to activate any money related services on the virtual card, such as making payments or ordering.

FIG. 6 illustrates an approach for a vendor to verify his business through a CCMS automatic phone service. A vendor staff starts the verification process by dialing CCMS supplied 1-800 number at block 602. At block 603, CCMS verifies that the caller's number from vendor's business location. If not, the verification process is terminated with a failure. At block 604, CCMS prompts the vendor staff to input the business verification code that the vendor received during the registration process. After successful verification at block 605, CCMS changes vender's UVC account to verified state at block 606 and call ends at block 607. If the verification code input by the vendor staff does not match the code stored in the CCMS, verification process will fail. This approach has a prerequisite: when vendor registers the business, the business phone numbers are imported from internet business directories and are not modified by the vendor. If the phone numbers are provided by the vendor during the registration, CCMS will not allow the vendor to verify his business using this approach.

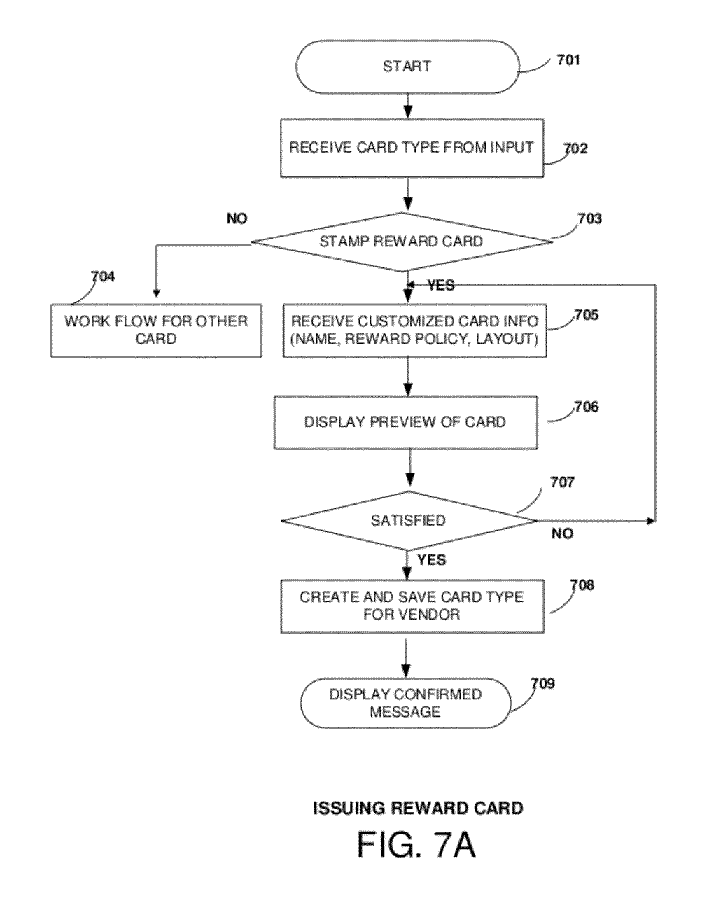

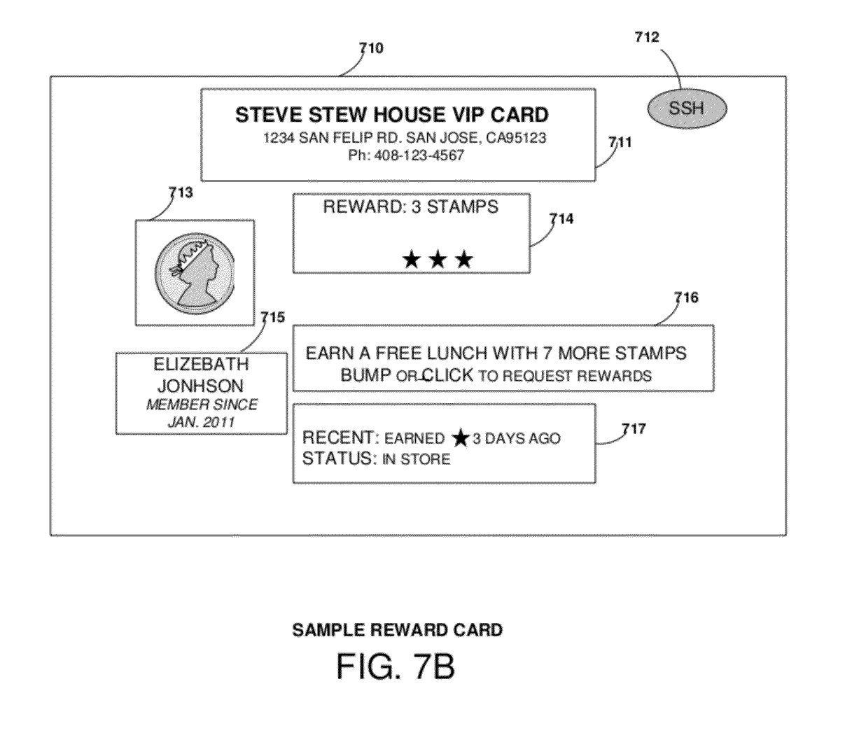

FIG. 7A illustrates the flow for a vendor to issue a reward card service through CCMS's web interface. At block 701, a vendor staff starts the virtual card service offering process and chooses the card type at block 702. After specifying the card type as stamp reward card, at block 703, CCMS receives information for card customization, such as card name, reward policy and card layout etc. at block 705. With supplied information, CCMS display a preview of the card on the web interface at block 706. After the vendor staff is satisfied with the preview, CCMS will save the card type into the vendor's UVC business account at block 708 or he can go back to block 705 for modifications. After CCMS displays the confirmation message at block 709, the virtual card service offered by the vendor is available for customers to use.

Once a vendor virtual card is issued, a user can find it by using VCMA's search function. The VVC can also automatically show up in the user's VCMA if he is in the vicinity of the vendor's store location. A vendor virtual card service does not necessarily require explicit signing up process. However, certain functionalities on the card service may need additional approval from its vendor before activation. Some vendor virtual cards can be used with full functionalities from beginning. Examples include most stamp cards, reward cards, and business information cards. Prepaid cards need to be loaded before they can be used for payments. User can still obtain a prepaid card and check related business information. However, the card will have a 0 balance at the beginning. User needs to pay with cash or credit card to load the card. In other cases, a card needs additional verification before its main functionality can be activated. Examples include library card (residence proof) and video rental card (driver license). A user can obtain a virtual card of this kind, but he still needs to visit a vendor store, provide the required verification information to a vendor staff, to have the card service activated. Before activation, he can only use the virtual card as a business information card. He cannot use the card to get the real services, such as borrowing books or renting videos.

FIG. 7B block 710 shows a sample reward card layout displayed on VCMA running on a smart phone. Virtual card information such as vendor's profile and reward policy as well as user profile and card usage information are displayed. The virtual card shows the vendor name, address and phone number in block 711. The vendor's logo is illustrated as block 712. By clicking on the logo, the menu for additional functionality can show up, such as: order, make payment, product menu, coupon box etc. Block 713 shows user's photo which can be used as the identification for security purpose. For example, when a user is using the virtual card at a store location, the photo on the virtual card confirms that the card holder is the person who is using the card. Block 714 is clickable and when clicked, recent transaction history can be displayed. In this example, it would show that the user earned a star 3 days ago, earned a star 7 days ago and earned a star 11 days ago. The display is similar to the call log/history on a smart phone. Block 715 is a link to some useful statistics, when clicked, a summary of all the rewards earned is displayed. For example, you have earned 100 stars and 10 free lunches since January, 2011. Block 716 can be implemented as a link as well, when clicked, detail reward policy can be displayed. For example: each purchase of a lunch box will earn you a star. Any purchase of $10 will also earn you a star, etc. Block 717 shows the recent activity and real time status. In this example, it shows the user just earned a reward star 3 days ago and he/she is currently in the vendor's location, a restaurant.

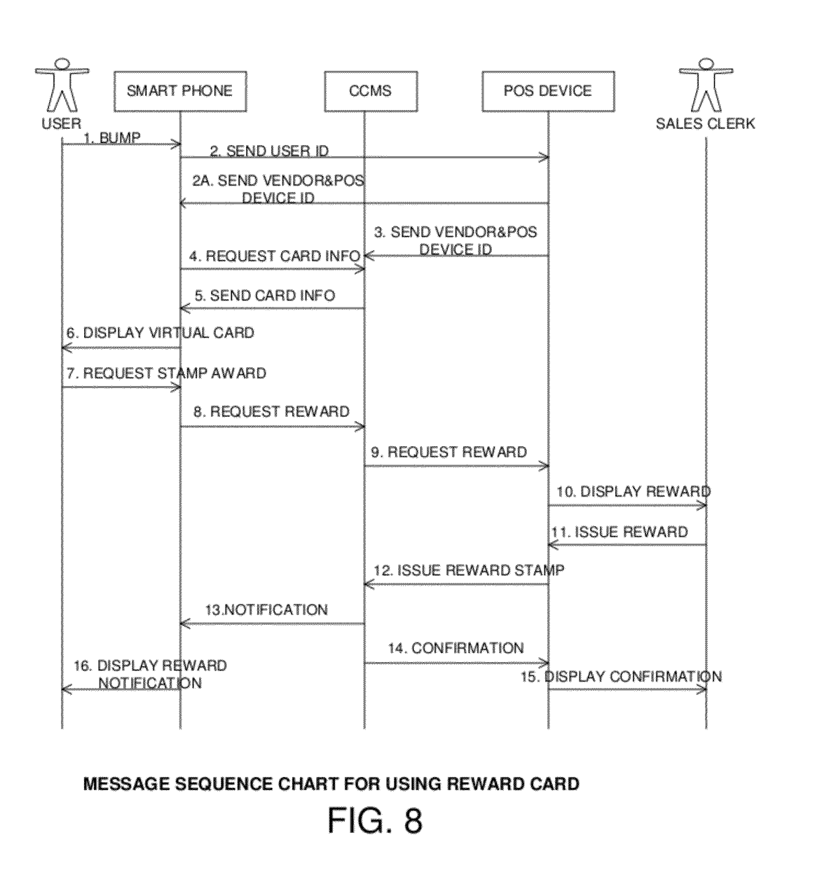

Referring now to FIG. 8, which is a message sequence chart for a user to request a reward at a vendor's store location. At step 1, user bumps the smart phone with vendor's POS device, usually a general-purpose computer where the virtual card store application (VCSA) is running. After bumping, VCMA and VCSA exchange their identifications for security purpose. In this particular embodiment, VCSA detects user identifier (ID) at step 2. At the same time VCSA send its vendor ID and POS device ID to the VCMA at step 2A. Then, VCSA connects to CCMS and sends vendor's ID together with the POS device ID to CCMS at step 3. At step 4, VCMA connects to CCMS and sends card info request to CCMS. After receiving both the requests from VCSA and VCMA, CCMS performs validation to make sure that the user ID and vendor ID are both valid. CCMS then connects the two parties together and starts forwarding information between them. Note that if either vendor ID or user ID fails for verification by CCMS, the transaction will be aborted for security purpose. CCMS sends card info to the VCMA for display at step 5. After user sees the display of the virtual card, he can request a stamp reward at step 7 on VCMA which sends the request to CCMS at step 8. The reward request is relayed to POS device by CCMS at step 9 and POS then displays the request to the sale clerk at step 10. At step 11, the sale clerk approves the request and issues the reward on POS device. The issuing message is transmitted all the way to user's smart phone at step 13 via CCMS at step 12. Finally, the confirmation message shows on the smart phone to notify that the reward is issued to the user.

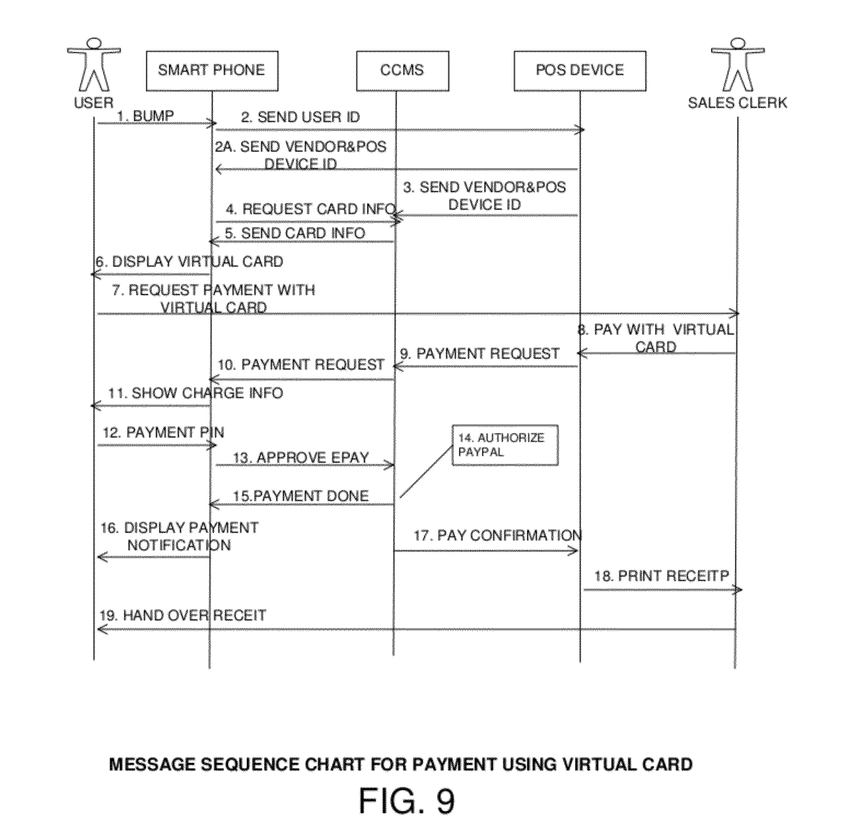

FIG. 9 is a message sequence chart for a user to make a payment using VCMA at a vendor's store location. At step 1, user bumps the smart phone with vendor's POS device, usually a general-purpose computer where the virtual card store application (VCSA) is running. After bumping, VCMA and VCSA exchange their identifications for security purpose. In this particular embodiment, VCSA detects user identifier (ID) at step 2. At the same time VCSA send its vendor ID and POS device ID to the VCMA at step 2A. Then, VCSA connects to CCMS and sends vendor's ID together with the POS device ID to CCMS at step 3. At step 4, VCMA connects to CCMS and sends card info request to CCMS. After receiving both the requests from VCSA and VCMA, CCMS performs validation to make sure that the user ID and vendor ID are both valid. CCMS then connects the two parties together and starts forwarding information between them. Note that if either vendor ID or user ID fails for verification by CCMS, the transaction will be aborted for security purpose. CCMS sends card info to the VCMA for display at step 5. After user sees the display of the virtual card, he can request a payment by phone to the sale clerk at step 7 and the sale clerk issue a “pay with VC” request at VCSA on POS device at step 8. The payment request is relayed to CCMS at step 9 and the charge information is displayed to the user at step 11 via VCMA on smart phone at step 10. At step 12, the user approves the payment request by inputting personal identification number (PIN) on smart phone which sends an approval message to CCMS to authorize the payment at step 13. After performing the payment transaction over an electronic payment system such as PayPal at step 14, CCMS sends payment completion message to user's smart phone at step 15. Finally, the confirmation message shows on the smart phone to notify user that the payment is completed.

What is claimed is:

1. A method for virtualizing a plurality of commercial wallet cards owned by a user, performed by a smart phone, comprising:
Sending registration information for signing up universal virtual card (UVC) service, wherein said registration information includes user profile and credential;
Providing virtual card management functionalities including searching a vendor virtual card (VVC), browsing products and services information, searching discount and coupons offered by said vendors, wherein said products and services information including price and availability; and
Conducting business transactions using said VVC services from said vendors; wherein the said business transactions including requesting rewards, receiving and redeeming coupons, ordering a product or service, making reservation, making payment;

2. The method of claim 1, wherein said user profile and credential can be imported from a user's existing on-line account.

3. The method of claim 1, further compromising:
Detecting and displaying available VVCs based on the location of said smart phone.

4. The method of claim 3, wherein said location of said smart phone is identified by using global position system (GPS) installed on the said smart phone.

5. A method for managing universal virtual card services, performed by a computer server, comprising:
Processing user registration requests for signing up universal virtual card (UVC) service and storing user profiles and credentials;
Processing vendor registration requests for signing on said UVC services and storing vendor's business profiles and login credentials;
Processing requests from vendors for adding and updating vendor virtual card (VVC) services; and
Processing business transactions conducted between said users and said vendors.

6. The method of claim 5, further comprising:
Activating a vendor's UVC service after vendor verification process is successfully completed, wherein said verification process is fully automatic by using 1-800 number service.

7. The method of claim 5, wherein vendor's business profiles can be imported from Internet.

8. A universal virtual card system comprising:
A computer server running central card management system (CCMS) storing a plurality of business accounts of vendors that are registered for the universal virtual card (UVC) service and a plurality of user accounts of consumers that are registered with said UVC service;
A plurality of point of sale (POS) computers running virtual card store application (VCSA) that is connected to said CCMS over internet;
A plurality of smart phones running virtual card mobile application (VCMA) that is connected to said CCMS over wireless data service and internet; and
A plurality of Internet browsers used by vendors, therein the said browser is connected to the said CCMS.

9. The system of claim 8, wherein said CCMS processes registration requests from said VCMAs for signing up universal virtual card (UVC) service.

10. The system of claim 8, wherein said CCMS processes registration requests from said internet browsers for signing up said UVC service.

11. The system of claim 8, wherein said CCMS processes requests from said internet browsers for offering and updating vendor virtual card (VVC) services.

12. The system of claim 8, wherein said CCMS connects to a plurality of vendor's backend systems and imports product and service information from said backend systems, wherein said product and service information include product catalogue, price and availability, coupons and specials.

13. The system of claim 8, wherein said CCMS coordinates business transactions between said VCMAs and said VCSAs, wherein said business transactions include requesting rewards, redeeming coupons, ordering a product and service, making reservation and making payment.

14. The system of claim 13, wherein said VCSAs conduct said business transactions by detecting user identification, displaying user information, issuing rewards and requesting payment.

15. The system of claim 13, wherein said VCMAs conduct said business transactions by detecting vendor identification, requesting rewards and making payment.

16. The system of claim 13, wherein said CCMS connects to a plurality of external electronic payment systems for initiating payment transactions.
